(19) United States
(12) Patent Application Publication
(10) Pub. No.: US 2024/0090545 A1
(43) Pub. Date: Mar. 21, 2024

(54) CITRUS MODIFIER COMPOUNDS IN CANNABIS

(71) Applicant: Abstrax Tech Inc., Tustin, CA (US)

(72) Inventors: Iain W.H. OSWALD, Tustin, CA (US); Marcos A. OJEDA, Tustin, CA (US); Kevin A. KOBY, Tustin, CA (US); Thomas J. MARTIN, JR., Tustin, CA (US)

(21) Appl. No.: 18/243,148

(22) Filed: Sep. 7, 2023

Related U.S. Application Data
(60) Provisional application No. 63/404,812, filed on Sep. 8, 2022.
(60) Provisional application No. 63/500,787, filed on May 8, 2023.

(51) Int. Cl. A23L 27/10; A23L 2/56; A23L 27/00; A23L 27/20; A23L 27/29; A24B 15/30

(52) U.S. Cl. CPC A23L 27/10; A23L 2/56; A23L 27/2022; A23L 27/29; A23L 27/88; A24B 15/303

(57) ABSTRACT

An edible composition, an aerosol composition, a flavor composition, a fragrance composition, or an inhalable composition includes an aroma compound such as 3-mercaptohexyl acetate (3MHA), 3-mercaptohexyl butyrate (3MHB), 3-mercaptohexanol (3MH), 3-mercaptohexyl hexanoate (3MHH), or a combination of any two or more thereof, one or more terpenes, and optionally one or more organosulfur compounds.

### CROSS REFERENCE TO RELATED APPLICATIONS

This application claims the benefit of U.S. Provisional Application No. 63/404,812, filed Sep. 8, 2022 and U.S. Provisional Application No. 63/500,787, filed May 8, 2023, the disclosures of which are incorporated herein by reference in their entireties.

### FIELD

The present invention relates to various compositions, products, and methods that are capable of, or adapted to, providing, augmenting, or enhancing the fragrance and flavor profile of products. In particular, the present invention relates to unique citrus fragrance and flavor modifier compounds, compositions and products thereof, and methods that are capable of, or adapted to, providing, augmenting, or enhancing the citrus fragrance and flavor.

### BACKGROUND

The following discussion is provided to aid the reader in understanding the disclosure and is not admitted to describe or constitute prior art thereto.

Cannabis is one of the most popular recreational drugs and it has recently seen significant changes to its legality within the United States and other countries. Cannabis is well known to produce a wide variety of scents that arise from the combination of hundreds of different volatile aroma compounds. Traditionally, much attention has focused on compounds of the terpenoid class when discussing the major components of this plant's aroma. However, recent research has shown that although they may indeed have the highest concentration in cannabis varieties, other chemical classes are far more important when characterizing the scent of cannabis. For instance, a recently discovered class of volatile sulfur compounds (VSCs) compounds that contain sulfur were found to be the source of the “skunky” and/or “gassy” aroma in certain cannabis cultivars. These compounds were identified in very low concentrations relative to the major aroma compounds yet produce some of the most potent aromas this plant creates.

The presence of various secondary metabolites, terpenes, terpenoids, sesquiterpenes, and sesquiterpenoids results in Cannabis products having a wide variety of aromas and flavors with remarkable depth and complexity. Cannabis produces a wide range of scents that can range wildly depending on the cultivar. For instance, Jack Herer is a strain of cannabis that is known to possess a woody and citrus aroma, whereas the OG Kush strain produces an earthy, gasoline-like scent. Fruity strains including citrus strains such as “tangie” (or “Tangie”) are gaining popularity for their refreshing citrus aroma. A unique subset of cultivars possesses a strong, pungent, fatty, gassy, fuel-petroleum-citrus scent and flavor. These cultivars include Sour Tangie, Tropicana Cookies, Orange Banana, and others. Although these cultivars are known to possess this unique citrus aroma, the specific chemical composition that helps to create this scent have not been definitively identified.

### SUMMARY

According to a first aspect, a composition comprises an aroma compound selected from 3-mercaptohexyl acetate (3MHA), 3-mercaptohexyl butyrate (3MHB), 3-mercaptohexanol (3MH), 3-mercaptohexyl hexanoate (3MHH), or a combination of any two or more thereof, and a primary terpene, wherein the composition is an edible composition, an aerosol composition, a flavor composition, a fragrance composition, or an inhalable composition. In certain embodiments, the aroma compound is exogenously added to the composition.

In certain embodiments, the composition comprises about 0.0000001 wt. % to about 0.3 wt. % of the aroma compound, based on the total weight of the composition. In certain embodiments, the aroma compound comprises 3-mercaptohexyl acetate, 3-mercaptohexyl butyrate, 3-mercaptohexanol, 3-mercaptohexyl hexanoate, or a combination of any two or more thereof.

In certain embodiments, the composition comprises a primary terpene compound selected from the group consisting of myrcene, β-caryophyllene, limonene, α-pinene, β-pinene, valencene, ocimene, terpinolene, or a combination of any two or more thereof. In certain embodiments, the primary terpene compound is present in an amount of from about 0.1 wt. % to about 99 wt. %, based on the total weight of the composition. In certain embodiments, the primary terpene compound is present in an amount of from about 0.1 wt. % to about 90 wt. %, based on the total weight of the composition. In certain embodiments, the composition further comprises a secondary terpene compound selected from the group consisting of humulene, linalool, bisabolol, nerol, phellandrene, terpineol, farnesene, fenchyl alcohol, geraniol, menthol, citronellol, citronellal, geranyl acetate, nerolidol, citral, or a combination of any two or more thereof. In certain embodiments, the secondary terpene compound is present in an amount of from about 0.01 wt. % to about 50 wt. %, based on the total weight of the composition. In certain embodiments, the composition further comprises a second flavoring and/or fragrance agent. In certain embodiments, the second flavoring and/or fragrance agent may be present in an amount of about 0.000001% to about 90% by weight, based on the total weight of the composition.

The composition containing the aroma compounds can be formulated into various forms of products. In certain embodiments, the composition is an edible composition. In certain embodiments, the composition is a food or beverage product. In certain embodiments, the beverage is beer, an alcohol containing beverage, or other non-alcohol containing beverage product. In certain embodiments, the composition is an inhalation composition. In certain embodiments, the composition is a flavor and/or fragrance composition.

According to another aspect, provided is for augmenting or enhancing the citrus aroma or taste of a product, the process comprising the step of adding to said product an aroma compound selected 3-mercaptohexyl acetate (3MHA), 3-mercaptohexyl butyrate (3MHB), 3-mercaptohexanol (3MH), 3-mercaptohexyl hexanoate (3MHH), or a combination of any two or more thereof. In certain embodiments, the product is an edible product, an aerosol product, a flavor product, a fragrance product, or an inhalable product. In certain embodiments, the product is an edible product or an inhalable product. In certain embodiments, the edible product is a food or beverage product. In certain embodiments, the beverage is beer, any alcohol containing beverage, or other non-alcohol containing beverage product.

In certain embodiments, the aroma compound is added in an amount of from about 00000001 wt. % to about 0.3 wt. %, based on the total weight of the product. In certain embodiments of the fourth aspect, the aroma compound comprises about 0.0000001 wt. % to about 0.3% of 3-mercaptohexyl acetate, about 0.0000001 wt. % to about 0.2 wt. % of 3-mercaptohexyl butyrate, about 0.0000001 wt. % to about 0.3% of 3-mercaptohexanol, about 0.0000001 wt. % to about 0.3% of 3-mercaptohexyl hexanoate, or a combination of any two or more thereof. In certain embodiments, the process further comprises adding a primary terpene compound selected from the group consisting of β-caryophyllene, limonene, α-pinene, β-pinene, valencene, ocimene, terpinolene, myrcene, or a combination of any two or more thereof. In certain embodiments, the primary terpene compound is added in an amount of from about 0.1 wt. % to about 99 wt. %, based on the total weight of the composition.

The foregoing summary is illustrative only and is not intended to be in any way limiting. In addition to the illustrative aspects, embodiments and features described above, further aspects, embodiments and features will become apparent by reference to the following drawings and the detailed description.

### BRIEF DESCRIPTION OF THE DRAWINGS

FIG. 1 represents structures of compounds discovered contributing to citrus odor in cannabis.

FIG. 2 represents 2-Dimensional chromatograms of the GC×GC-TOF-MS and GC×GC-SCD highlighting 3MHA, 3MH, 3MHH and 3MHB in a Sour Tangie sample.

FIG. 3 represents 2-Dimensional chromatograms of the GC×GC-TOF-MS and GC×GC-SCD highlighting 3MHA in a Tropicana Cookies sample.

FIG. 4 represents 2-Dimensional chromatograms of the GC×GC-TOF-MS and GC×GC-SCD highlighting 3MHA in an Orange Banana sample.

FIGS. 5A-5D show mass spectrum of 3MHA, 3MHB, 3MHH, and 3MH respectively, in a Sour Tangie sample overlaid with the respective mass spectrum of 3MHA, 3MHB, 3MHH, and 3MH obtained from the NIST mass spectral database.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified. As a non-limiting example, a reference to “X and/or Y” can refer, in one embodiment, to X only (optionally including elements other than Y); in another embodiment, to Y only (optionally including elements other than X); in yet another embodiment, to both X and Y (optionally including other elements).

Unless indicated otherwise, reference to “percent” is to be understood as “weight percent,” and reference to “ratio” is as a weight/weight ratio.

As used herein, the term “terpene compound” is understood to mean any organic compound that contains at least one isoprene subunit within its structure and their oxygenated derivatives.

As used herein, the terms “odor” and “aroma” are used interchangeably and represent the sensory attributes of certain substances perceptibly determined by the olfactory system.

As used herein, the term “aroma compound” is a chemical compound that has, exhibits, emits, or imparts a smell or odor, and which is sufficiently volatile for transmission to the olfactory system. Aroma compounds may have organoleptic properties and/or encompass an odorant, aroma, fragrance, or flavoring agent or compound.

As used herein, the term “flavoring agent” is understood to mean an additive that is meant to improve the taste or aroma impression of food or other substances and can include both natural and synthetic ingredients.

As used herein, the term “fruity” is understood to be an organoleptic descriptor that represents a type of Cannabis aroma and/or flavor that emulates a fruit-like odor and/or flavor. The fruity aroma/flavor may include, for example, “citrus” organoleptic descriptor when tested using sensory testing methods. A non-limiting example of a fruity aroma is the Jack Herer cultivar. A non-limiting example of a citrus aroma is Tropicana Cookies cultivar. A non-limiting example of a strong citrus aroma is the Tangie cultivar. Non-limiting examples of citrus aromas may include orange, lemon, lime, grapefruit, tangerine.

As used herein, the term “strain” is used to represent various chemovars or cultivars.

As used herein, the term “cultivar” represents a group of similar plants that by structural features and performance (i.e., morphological and physiological characteristics) can be identified from other varieties within the same species. Furthermore, the term “cultivar” variously refers to a variety, strain, or race of plant that has been produced by horticultural or agronomic techniques and is not normally found in wild populations. The terms cultivar, variety, strain, and race are often used interchangeably by plant breeders, agronomists, and farmers.

As used herein, the term “landrace” is used to represent a local variety of a domesticated plant species that has developed largely by natural processes, by adaptation to the natural and cultural environment in which it lives.

As used herein, the term “plant matter” is used to represent to any part of a plant including but not limited to the flower bud, leaf, petal, flower, stem, seed, embryo, shoot, root, stipule, ovule, bract, trichome, branch, petiole, internode, bark, pubescence, tiller, rhizome, frond, blade, ovule, pollen, stamen, and the like.

As used herein, the term “dry flower” is understood to mean a flower or bud of the plant matter that has been cured and dried and has less than about 0.63 water activity, or alternatively about 13% moisture by weight of the flower. Dry flower, or dry herb, is what is used for rolling into a smokable composition (i.e., a “joint”) or in an edible form, for example.

In some embodiments the plant matter may be ‘alive’ or ‘wet’ which means it is not cured. Thus, the contents of various components may be measured in terms of dry flow, wet flower, extracts, or otherwise.

The term “endogenous” as used herein refers to a component which is present and/or naturally expressed within a plant or a cell thereof. As used herein, the term “exogenous” refers to a component which may not be present and/or naturally expressed within the plant or cell thereof, e.g., a component which may be externally added.

Various aspects and/or embodiments of this disclosure relate to compositions, products, and methods that are capable of, or adapted to, providing, augmenting, or enhancing the fruity aroma, e.g., citrus odor or aroma. Other aspects and/or embodiments relate to plant species, cultivars, and methods of breeding plant species which include compounds capable of providing citrus odor or aroma and/or and modifying the olfactory qualities of the citrus aroma. Yet other aspects and/or embodiments relate to methods for analyzing and/or identifying the compounds that contribute to a citrus aroma associated with a product.

The invention is based on the surprising finding that a unique sub-set of compounds, e.g., volatile sulfur compounds, discovered in specific cannabis cultivars are capable of generating or imparting potent gassy, petroleum-citrus aromas and scents. These newly identified compounds, alone or in combination with the major terpenes (e.g., D-Limonene, Terpinolene, Linalool, and Pinene), and optionally along with other organosulfur compounds (e.g., prenylated volatile sulfur compounds), generate unexpectedly unique citrus flavors and aromas, which can be used to flavor a wide variety of consumer products. Instead of taking on the more traditional “tropical” aromas, these compounds were surprisingly and unexpectedly found to provide a unique citrus aroma/flavor, i.e., a fatty, gassy, fuel-petroleum-citrus aroma/flavor.

Provided herein are compositions comprising compounds that are capable of providing a citrus aroma and/or and modifying the olfactory qualities of the citrus aroma. In certain embodiments, the compositions may include aroma compounds for providing a citrus aroma and/or modifying the olfactory qualities of the citrus aroma. Suitable aroma compounds may include terpenes and organosulfur compounds, such as for example and without limitation, mercaptans, thiols, sulfides, disulfides, polysulfides, and thioesters that contribute to or enhance the desired aroma and/or olfactory qualities of the composition.

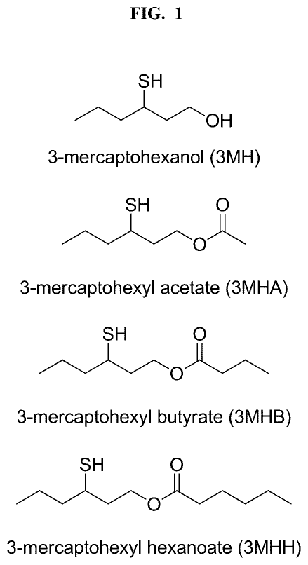

Individual substances (aroma compounds) which may be included in the compositions may include, without limitation, 3-mercaptohexyl acetate (3MHA), 3-mercaptohexanol (3-MH), 3-mercaptohexyl hexanoate (3MHH) and 3-mercaptohexyl butyrate (3MHB) In certain embodiments, the aroma compound includes 3-mercaptohexyl acetate, 3-mercaptohexyl butyrate, 3-mercaptohexanol, 3-mercaptohexyl hexanoate, or a combination of any two or more thereof. In certain embodiments, the aroma compound includes 3-mercaptohexyl acetate. In certain embodiments, the aroma compound includes 3-mercaptohexyl butyrate. In certain embodiments, the aroma compound includes 3-mercaptohexanol. In certain embodiments, the aroma compound includes 3-mercaptohexyl hexanoate. Any combination of the aroma compounds disclosed here can be included in the compositions. Structures of illustrative aroma compounds that contribute to the desirable odor and flavor, e.g., citrus, in cannabis are illustrated in FIG. 1.

In certain embodiments, the aroma compounds may be present at up to about 20% by weight of the total composition, up to about 15%, up to about 10%, up to about 5%, up to about 2%, up to about 1%, up to about 0.6%, up to about 0.3%, up to about 0.2% or up to about 0.1% by weight of the total weight of the composition. For example, the aroma compounds are present in the composition from at least about 0.0000001% by weight of the total composition, at least about 0.000001%, at least about 0.00001%, at least about 0.0001%, at least about 0.001%, at least about 0.01%, at least about 0.05% or at least about 0.1% by weight. This includes where the aroma compound is present from about 0.0000001% to about 10% of the total weight of the composition, including without limitation, about 0.00001% to about 5%, about 0.0001% to about 3%, about 0.001% to about 2%, or about 0.01% to about 1% of the total weight of the composition, about 0.0000001% to about 0.5%, about 0.0000001% to about 0.2%, about 0.0000001% to about 0.1%, or any range including and/or in-between any two of these values. In certain embodiments, the aroma compound is from about 0.000001 wt. % to about 0.3 wt. % of the total weight of the composition.

The composition may include about 0.0000001 wt. % to about 0.3 wt. % of the total weight of the composition, of aroma compounds. In certain embodiments, the composition includes about 0.0000001 wt. % to about 0.3 wt. % of the total weight of the composition, of 3-mercaptohexyl acetate. In certain embodiments, the composition includes about 0.0000001 wt. % to about 0.2 wt. % of the total weight of the composition, of 3-mercaptohexyl butyrate. In certain embodiments, the composition includes about 0.0000001 wt. % to about 0.2 wt. % of the total weight of the composition, of 3-mercaptohexanol. In certain embodiments, the composition includes about 0.0000001 wt. % to about 0.2 wt. % of the total weight of the composition, of 3-mercaptohexyl hexanoate. Various combinations of aroma compounds may also be used in the compositions. Thus, in certain embodiments, the composition includes one or more of about 0.0000001 wt. % to about 0.3 wt. % of the total weight of the composition, of 3-mercaptohexyl acetate and about 0.0000001 wt. % to about 0.2 wt. % of the total weight of the composition, of 3-mercaptohexyl butyrate and about 0.0000001 wt. % to about 0.3 wt. % of the total weight of the composition, of 3-mercaptohexanol. In certain embodiments, the composition includes about 0.0000001 wt. % to about 0.3 wt. % of the total weight of the composition, of 3-mercaptohexyl hexanoate.

The compositions, in addition to the aroma compound, may include an organosulfur compound selected from prenyl mercaptan, 2-methylthiophene, 3-methylthiophene, dimethyl di sulfide, di prenyl disulfide, 3-methyl-2-buten-1-yl thiolacetate, 3-methyl-1-[(3-methyl-2-buten-1-yl)sulfanyl]-2-butene, prenylmethylsulfide (1-(m ethylsulfanyl)-3-methyl-2-butene), prenyl thioacetate, thiogeraniol, and dimethyl sulfide, or a combination of any two or more thereof. These organosulfur compounds are added to provide a gassy or skunky feature to the compositions. The composition may include about 0.000001 wt. % to about 0.3 wt. % of the total weight of the composition, of organosulfur compounds.

In addition to the aroma compounds, in certain embodiments, the compositions may include one or more terpene compounds. Non-limiting examples of terpene compounds include hemiterpenes, monoterpenes, sesquiterpenes, diterpenes, sesterterpenes, triterpenes, sesquarterpenes, tetraterpenes, polyterpenes, terpenoids and noriso-prenoids. Suitable terpene compounds may include a primary terpene compound and a secondary terpene compound. Illustrative primary and secondary terpene compounds include, without limitation, myrcene, β-caryophyllene, α or β-Pinene, α or β-phellandrene, limonene, terpinolene, linalool, pinene, terpineol, fenchyl alcohol, α-bisabolol, camphene, terpinolene, humulene, geraniol, camphor, cedrene, 1-menthol, cis-β-ocimene, trans-β-ocimene, terpinene, delta-3-carene, isoborneol, nerol, valencene, farnesene (t), fenchone, ocimene, bergotamene, thujene, ylangene, sabinene hydrate, and the like, or a combination of any two or more thereof. Many other terpenes are known in the art, are commercially available, and can be used in the compositions.

For compositions described herein and containing aroma compound and terpenes, the combination of the aroma compound and terpene is not a combination found in nature, that is, the aroma compound does not naturally occur with the terpene. Thus, the composition is not a naturally occurring composition or one that is found in nature.

In certain embodiments, the primary terpene compounds may include, without limitation, myrcene, β-caryophyllene, limonene, α-pinene, β-pinene, valencene, ocimene and terpinolene, and the like, or a combination of any two or more thereof. In certain embodiments, the primary terpene compounds constitute a major amount of the total terpene content or is a major contributor to the resulting aroma of the composition. In certain embodiments, the primary terpene compounds constitute at least about 5% by weight of the total composition, at least about 10%, at least about 20%, at least about 30%, at least about 40%, at least about 50%, at least about 60%, at least about 70%, at least about 80% or at least about 90% by weight. In certain embodiments, the primary terpene compounds constitute up to about 99.99% by weight of the total composition, up to about 99%, up to about 95%, up to about 92%, up to about 90%, up to about 85% or up to about 80% by weight of the total weight of the composition. In certain embodiments, the primary terpene compound constitutes about 5% to about 99.99% of the total weight of the composition, including without limitation, about 10% to about 98%, about 20% to about 98%, about 30% to about 98%, about 40% to about 98%, about 50% to about 95%, about 60% to about 90%, or about 70% to about 85% of the total weight of the composition, or any range including and/or in-between any two of these values.

In certain embodiments, the primary terpene compound is present in an amount of from about 0.1 wt. % to about 90 wt. %, based on the total weight of the composition. In certain embodiments, the composition includes about 0.1 wt. % to about 90 wt. % of the total weight of the composition, of myrcene. In certain embodiments, the composition includes about 0.1 wt. % to about 90 wt. % of the total weight of the composition, of β-caryophyllene. In certain embodiments, the composition includes about 0.1 wt. % to about 90 wt. % of the total weight of the composition, of limonene. In certain embodiments, the composition includes about 0.1 wt. % to about 90 wt. % of the total weight of the composition of α-pinene. In certain embodiments, the composition includes about 0.1 wt. % to about 90 wt. % of the total weight of the composition of β-pinene. In certain embodiments, the composition includes about 0.1 wt. % to about 90 wt. % of the total weight of the composition of valencene. In certain embodiments, the composition includes about 0.1 wt. % to about 90 wt. % of the total weight of the composition of ocimene. In certain embodiments, the composition includes about 0.1 wt. % to about 90 wt. % of the total weight of the composition of terpinolene.

In certain embodiments, the compositions include a secondary terpene compound. In certain embodiments, the secondary terpene compounds may include, without limitation, humulene, linalool, α-bisabolol, nerol, α-phellandrene, α-terpineol, farnesene, fenchyl alcohol, geraniol, menthol, citronellol, citronellal, geranyl acetate, nerolidol, citral, and the like, or a combination of any two or more thereof. In certain embodiments, the secondary terpene compounds constitute a minor amount of the total terpene content or is a minor contributor to the resulting aroma of the composition. In certain embodiments, the secondary terpene compounds constitute up to about 30% by weight of the total composition, up to about 20%, up to about 10%, up to about 5%, up to about 2%, up to about 1% or up to about 0.1% by weight of the total weight of the composition. In certain embodiments, the secondary terpene compounds constitute at least about 0.0001% by weight of the total composition, at least about 0.001%, at least about 0.01%, at least about 0.1%, at least about 0.5%, at least about 1% or at least about 2% by weight. In certain embodiments, the secondary terpene compound constitutes about 0.0001% to about 30% of the total weight of the composition, including without limitation, about 0.001% to about 25%, about 0.1% to about 20%, about 1% to about 10%, or about 2% to about 5% of the total weight of the composition, or any range including and/or in-between any two of these values. In certain embodiments, the secondary terpene compound is present in an amount of from about 0.01 wt. % to about 10 wt. %, based on the total weight of the composition.

In certain embodiments, the secondary terpene compound is present in an amount of from about 0.1 wt. % to about 30 wt. %, based on the total weight of the composition. In certain embodiments, the composition includes about 0.1 wt. % to about 30 wt. % of the total weight of the composition, of one or more secondary terpenes selected from humulene, linalool, α-bisabolol, nerol, α-phellandrene, α-terpineol, farnesene, fenchyl alcohol, geraniol, menthol, citronellol, citronellal, geranyl acetate, nerolidol and citral.

In certain embodiments, the composition includes about 0.000001 wt. % to about 0.3 wt. % of prenyl mercaptan (also known as prenyl thiol or 3-methyl-2-butene-1-thiol) and about 0.1 wt. % to 90 wt. % myrcene, based on the total weight of the composition. In certain embodiments, the composition includes about 0.000001 wt. % to about 0.3 wt. % of prenyl mercaptan, about 0.1 wt. % to 90 wt. % myrcene, and about 0.1 wt. % to 90 wt. % D-limonene, based on the total weight of the composition. In certain embodiments, the composition includes about 0.000001 wt. % to about 0.3 wt. % of prenyl mercaptan, about 0.1 wt. % to 90 wt. % myrcene, about 0.1 wt. % to 90 wt. % of D-limonene, and about 0.1 wt. % to 90 wt. % of β-Caryophyllene based on the total weight of the composition. In certain embodiments, the composition includes about 0.000001 wt. % to about 0.3 wt. % of prenyl mercaptan, about 0.000001 wt. % to about 0.3 wt. % of 2-methylthiophene, about 0.1 wt. % to 90 wt. % myrcene, about 0.1 wt. % to 90 wt. % of D-limonene, and about 0.1 wt. % to 90 wt. % of β-caryophyllene-based on the total weight of the composition.

In another aspect, the composition can be formulated to have various applications. In certain embodiments, the aroma compound is natively present in the composition, e.g., a cannabis extract. Generally, the aroma compounds described herein may be exogenously added to the composition, that is, the composition in itself does not have the aroma compound as native to it. In a non-limiting way, the composition can be an edible composition, an aerosol composition, a flavor composition, a fragrance composition, or an inhalable composition. In certain embodiments, an edible product comprising a composition described herein is provided. In certain embodiments, the composition is an edible composition. In certain embodiments, the composition is an aerosol composition. In certain embodiments, the composition is a flavor composition. In certain embodiments, the composition is a fragrance composition. In certain embodiments, the composition is an inhalable composition.

The compositions may further include suitable second flavoring and/or fragrance agents including, but not limited to, ethyl butyrate, ethyl isovalerate, methyl anthranillate, vanillin, ethyl maltol, maltol, strawberry furanone (4-OH-2,5-dimethyl-3-furanone), raspberry ketone (anisyl acetone), isoamyl acetate, isoamyl butyrate, ethyl caproate, octanal, octanol, aldehyde c-16, allyl caproate, ortho-tolualdehyde, benzaldehyde, sweet almond oil, bitter almond oil, beta-ionone, hexyl butyrate, hexyl acetate, hexyl hexanoate, propyl caproate, folione, citronellyl formate, 2-phenylpropyl isobutyrate, propionyl thiazole, methional, methyl heptadienone, gamma decalactone, melonal, passifloran, methyl-2 butyl acetate, lime terpenes, peppermint oil, orange oil, and the like, or a combination of any two or more thereof. Additional examples of flavoring agents include ingredients that are “generally recognized as safe” (“GRAS”) by the United States Food and Drug Administration (“FDA”), for example, those listed as approved under 21 C.F.R. §§ 172.510, 172.515, and 172.560.

In certain embodiments, the second flavoring and/or fragrance agents, when present, constitutes about 0.000001% to about 90% by weight of the total weight of the composition, including without limitation, about 0.000001% to about 80%, about 0.000001% to about 70%, about 0.000001% to about 60%, about 0.000001% to about 50%, about 0.000001% to about 40%, about 0.000001% to about 30%, about 0.000001% to about 20%, about 0.00001% to about 15%, about 0.0001% to about 10%, about 0.001% to about 8%, about 0.01% to about 5%, about 0.1% to about 3%, or about 1% to about 2% by weight of the total weight of the composition, or any range including and/or in-between any two of these values.

Depending upon the end application, the compositions may include other ingredients, such as surfactants, co-solvents, propellants, other flavoring agents, medicinal agents, perfumes, stabilizers, thickeners, binders, preservatives, emulsifiers, essential oils, water, salt, sweeteners, gelatin, food additives, colorants, excipients, diluents, and the like or a combination of any two or more thereof.

The aroma compounds and compositions described herein may be used in any flavor and fragrance applications. Accordingly, in one aspect, provided herein are flavor and fragrance compositions comprising aroma compounds including, but not limited to, prenyl mercaptan, 2-methylthiophene, 3-methylthiophene, dimethyl disulfide, diprenyl disulfide, 3-methyl-2-buten-1-yl thiolacetate, 3-methyl-1-[(3-methyl-2-buten-1-yl)sulfanyl]-2-butene, and a compound selected from the group consisting of 3-mercaptohexyl acetate (3MHA), 3-mercaptohexyl butyrate (3MHB) and a terpene compound. In certain embodiments, the aroma compound includes 3-mercaptohexyl acetate (3MHA), 3-mercaptohexyl butyrate (3MHB), 3-mercaptohexanol (3MH), and 3-mercaptohexyl hexanoate (3MHH).

In certain embodiments, the compositions may further include a cannabinoid active agent. The cannabinoid active agent may be selected from any of the known cannabinoids, including, without limitation, tetrahydrocanabinols, tetrahydrocannabinolic acids, cannabidiol, cannabidiolic acid, cannabigerolic acid, cannabigerol, cannabigerovarinic acid, cannabigerolovarin, cannabichromenic acid, cannabichromene, cannabidivarin, cannabidivarinic acid, cannabivarin, cannabivarinic acid, tetrahydrocannabivarinic acid, tetrahydrocannabivarin, cannabinolic acid, cannabinol, cannabinodiol, cannabielsoin, cannabicyclol, and cannabicitran and isomers thereof, or a combination of any two or more thereof. When used, the cannabinoid active agent is present in an amount of from about 0.05% to 99.9% by wt. based on the total weight of composition, including from 0.1 to 45%, 1 to 40%, 2 to 35%, 5 to 30%, or 10 to 20% by wt., based on the total weight of the composition.

The compositions described herein may be used in a variety of products including edible products, aerosol products, fragrance products, flavor products, inhalable products, consumer products, personal care products, and household products. The aroma compound-containing compositions containing one or more aroma compounds may synergistically enhance the olfactory effects of products to closely emulate fruity aroma and/or flavor, e.g., citrus aroma and/or flavor. In certain embodiments, the aroma compound-containing compositions can be used as an additive to synergistically enhance the aroma and/or flavor of products such as edible products, aerosol products, fragrance products, flavor products, inhalable products, consumer products, personal care products, and household products. In certain embodiments, the edible product is a food product or a beverage product.

In another aspect, the present technology relates to various products that may include the aroma compound-containing compositions described herein. Illustrative products include, without limitation edible products, aerosol products, fragrance products, flavor products, or inhalable products. In certain embodiments, an edible product comprising a composition described herein is provided. In certain embodiments, the edible product is a food or beverage product. In certain embodiments, the beverage is beer, any alcohol containing beverage, or other non-alcohol containing beverage product. In certain embodiments, a flavor and fragrance product comprising a composition described herein is provided. In certain embodiments, an inhalation product comprising the composition described herein is provided. In certain embodiments, the inhalation product is a vaping composition. In certain embodiments, a flavor and/or fragrance delivery system comprising the composition described herein is provided.

In another aspect, an edible product or an inhalation product comprises a composition comprising an aroma compound selected from the group consisting of 3-mercaptohexyl acetate (3MHA), 3-mercaptohexanol (3MH), 3-mercaptohexyl butyrate (3MHB), and 3-mercaptohexyl hexanoate (3MHH). In certain embodiments, the composition includes from about 0.0000001 wt. % to about 0.3 wt. % of 3-mercaptohexyl acetate, based on the total weight of the composition. In certain embodiments, the composition comprises from about 0.0000001 wt. % to about 0.2 wt. % of 3-mercaptohexyl butyrate, based on the total weight of the composition. In certain embodiments, the composition includes from about 0.0000001 wt. % to about 0.3 wt. % of 3-mercaptohexanol, based on the total weight of the composition. In certain embodiments, the composition includes from about 0.0000001 wt. % to about 0.3 wt. % of 3-mercaptohexyl hexanoate, based on the total weight of the composition.

In another aspect, the present technology relates to various products that may include the compositions described herein. Illustrative products include, but are not limited to edible products, aerosol products, fragrance products, flavor products, or inhalable products. In certain embodiments, an edible product comprising a composition described herein is provided. In certain embodiments, the edible product is a food or beverage product. In certain embodiments, the food product may include candy, licorice, taffy, chews, gummies, jelly bean, and the like. In certain embodiments, the beverage is beer, any alcohol containing beverage, or other non-alcohol containing beverage product. In certain embodiments, a flavor and fragrance product comprising a composition described herein is provided. In certain embodiments, an inhalation product comprising the composition described herein is provided. In certain embodiments, the inhalation product is a vaping composition. In certain embodiments, a flavor and/or fragrance delivery system comprising the composition described herein is provided.

Depending upon the end application, the compositions may include other ingredients, such as additives, surfactants, co-solvents, propellants, other flavoring agents, medicinal agents, perfumes, stabilizers, thickeners, binders, preservatives, emulsifiers, essential oils, water, salt, sweeteners, gelatin, food additives, colorants, excipients, diluents, fatty acids, triglycerides, terpenes, flavanoids and the like or a combination of any two or more thereof. For example, the compositions may include other phyto-derived compounds, i.e., nitrogenous compounds, amino acids, proteins, enzymes, glycoproteins, hydrocarbons, alcohols, aldehydes, ketones, fatty acids, esters and lactones, steroids, terpenes, non-cannabinoid phenols, flavonoids, vitamins and pigments. In certain embodiments, the compositions may include commonly used terpenes, sesquiterpenes, and their oxygenated derivatives, or canninoid products. In certain embodiments, the compositions may include flavor modifiers, fragrance modifiers or a combination thereof. In certain embodiments, the flavor modifiers may include terpene compounds. Illustrative terpene compounds are described herein. In certain embodiments, the terpenes may be exogenously added to the composition or endogenously present in the compositions. In certain embodiments, the terpenes may be exogenously added to the composition.

Other aspects of the present technology relate to Cannabis plants. The Cannabis plant may be a hybrid plant or an engineered plant, and can be produced via known methods such as seed production or asexual reproduction. In some embodiments, provided is a cannabis plant, or an asexual clone thereof, or a plant part, tissue, or cell thereof comprising an aroma compound content greater than 0.00001 μg/mg as measured by gas chromatography coupled with a sulfur chemiluminescence detector and calculated based on dry weight of the dried, ground flower. In certain embodiments, the aroma compound includes 3-mercaptohexyl acetate, 3-mercaptohexyl butyrate, 3-mercaptohexanol, 3-mercaptohexyl hexanoate, or a combination of any two or more thereof. The gas chromatography can be one-dimensional or a two-dimensional gas chromatography coupled with a sulfur chemiluminescence detector (GC×GC-SCD) or a comprehensive two-dimensional gas chromatography/time-of-flight mass spectrometry (GC×GC-TOF-MS). In some embodiments, aroma compound content is greater than about 0.00001 μg/mg, greater than about 0.0002 μg/mg, greater than about 0.0005 μg/mg, greater than about 0.0007 μg/mg, greater than about 0.001 μg/mg %, greater than about 0.005 μg/mg, or greater than about 0.01 μg/mg as measured by gas chromatography coupled with a flame ionization detector (FID) or a sulfur chemiluminescence detector and calculated based on dry weight of the dried, ground cannabis flower. In some embodiments, aroma compound content is less than about 0.1 μg/mg as measured by gas chromatography coupled with a FID and calculated based on dry weight of the dried, ground flower In some embodiments, aroma compound content is less than about 0.05 μg/mg, less than about 0.01 μg/mg, less than about 0.005 μg/mg, less than about 0.003 μg/mg, greater than about 0.002 μg/mg, or greater than about 0.001 μg/mg as measured by gas chromatography coupled with a FID and calculated based on dry weight of the dried, ground cannabis flower.

Methods for analyzing and/or identifying the compounds that contribute to a citrus aroma associated with a product, e.g., a cannabis product, are also provided herein. The methods include analyzing the constituents of a product having a citrus aroma using various devices and methods including, but not limited to, gas chromatography/time-of-flight mass-spectrometer (GC/TOF-MS), two-dimensional gas chromatography-time of flight mass spectrometry (2DGC-TOF MS), flame ionization detector (FID), sulfur chemiluminescence detector (SCD), gas chromatography/mass spectrometry (GC/MS), gas chromatography with atomic emission detector (GC/AED), gas chromatography/flame ionization detection/olfactometry (GC/FID/olfactometry) or high performance liquid chromatography (HPLC), or a combination of any two or more thereof.

Cannabis strains and compositions with varying degrees of citrus aroma may be analyzed using 2-dimensional gas chromatography equipped with a time-of-flight mass-spectrometer (TOF-MS), flame ionization detector (FID), and a sulfur chemiluminescence detector (SCD). It has now been surprisingly and unexpectedly discovered that a correlation exists between the organoleptic response, i.e., how ‘citrus’ a given strain smells to the human nose, and the concentration of certain aroma compounds. Such aroma compounds may include, without limitation, 3-mercaptohexyl acetate (3MHA), 3-mercaptohexanol (3MH), 3-mercaptohexyl hexanoate (3MHH), and 3-mercaptohexyl butyrate (3MHB). It was discovered that the odors of these aroma compounds coupled with terpene compounds present in a strain may yield the particular ‘flavor’ of the citrus present. Although low in relative concentration compared to the terpenes, the aroma compounds were found to have a significant impact on aroma and flavor. The methods for identification and analysis of the odor-producing compounds described herein can advantageously be used to guide cultivators for targeting and producing plants, clones, or plant cells with or without specific aromas associated with them, as well as develop formulations of food and beverages when targeting a unique citrus aroma or odor.

One aspect of the present technology relates to a method for detecting citrus aroma compounds in a cannabis plant by analyzing the headspace gas from a cannabis sample using a gas chromatography. The gas chromatography can be a one- or two-dimensional gas chromatograph coupled a sulfur chemiluminescence detector (SCD). The SCD can be used in conjugation with other detectors such as a flame ionization detector (FID), a mass spectrometer (MS), nitrogen chemiluminescence detector (NCD), a nitrogen phosphorus detector (NPD), an atomic emission detector (AED), a flame photometric detector (FPD), or an electron capture detector (ECD). Suitable samples of the cannabis plant material can be placed in a bottle and the gases in a headspace bottle, can be collected using headspace tools and injected into an FID combined device, using an inert gas such as nitrogen as carrier gas for the gas chromatography, and performing qualitative and quantitative detection through a FID. The cannabis samples can be incubated and agitated at suitable temperature (e.g., 40-150° C.) prior to collection of the headspace gas sample. In some embodiments, the cannabis sample may include cannabis flower material, such as dried flower, dried, and ground flower, a wet flower, or a flower extract. In some embodiments, the flower material may be cured. In some embodiments, the flower material may be uncured.

Instrument parameters that can be used in a 2-dimensional gas chromatographic system include using an INSIGHT™ reverse fill flush flow modulator (SepSolve Analytical) coupled to an Agilent 7890B GC and BenchTOF Select Time of flight mass spectrometer (Markes International).

A suitable instrument temperature ramp method may include: an initial temperature of 45° C., the temperature is maintained for 3 min, the temperature is increased to 90° C. at the speed of 5° C./min, then the temperature is increased to 130° C. at the speed of 2° C./min, the temperature is increased to 240° C. at the speed of 5° C./min, and the temperature is maintained for 1 min. The modulation period set for the flow modulator was 7.2 seconds. Data was collected, integrated, and analyzed using the ChromSpace software platform (Sepsolve Analytical).

Suitable instrument parameters include:
sample inlet temperature: 200° C.;
SCD plasma Burner temperature: 800° C.;
SCD Base temperature: 250° C.;
Oxidizer flow (02): 11.50 mL/min,
Upper H₂ flow: 38.00 mL/min; and
Upper H₂ flow: 8.00 mL/min.

Illustrative aroma compounds which may be detected or identified using the GC×GC-FID method, may include, without limitation, 3-mercaptohexyl acetate (3MHA), 3-mercaptohexanol (3MH), 3-mercaptohexyl hexanoate (3MHH) and 3-mercaptohexyl butyrate (3MHB).

Another aspect of the present technology relates to a process for augmenting or enhancing the citrus aroma or taste of a product by adding to the product an aroma compound selected from 3-mercaptohexyl acetate (3MHA), 3-mercaptohexanol (3MH), 3-mercaptohexyl hexanoate (3MHH), 3-mercaptohexyl butyrate (3MHB), or a combination of any two or more thereof. The aroma compound may be added in amounts as described herein, for example from about 0.000001 wt. % to about 20 wt. %, from about 0.000001 wt. % to about 0.6 wt. %, or from about 0.000001 wt. % to about 0.3 wt. %, based on the total weight of the product.

In certain embodiments, the process further includes adding a terpene compound to the product. Suitable terpene compounds may include the primary and secondary terpene compounds described herein. In certain embodiments, the primary terpene compound is selected from the group consisting of myrcene, β-caryophyllene, limonene, α-pinene, β-pinene, valencene, ocimene, and terpinolene. In certain embodiments, the secondary terpene compound is selected from the group consisting of humulene, linalool, α-bisabolol, nerol, α-phellandrene, α-terpineol, farnesene, fenchyl alcohol, geraniol, menthol, citronellol, citronellal, geranyl acetate, nerolidol, and citral. In certain embodiments, the primary terpene compound is added in an amount of from about 0.1 wt. % to about 90 wt. %, based on the total weight of the product. In certain embodiments, the secondary terpene compound is added in an amount of from about 0.01 wt. % to about 10 wt. %, based on the total weight of the composition.

In certain embodiments, provided herein is a process for augmenting or enhancing the citrus aroma or taste of a product selected from an edible product, an aerosol product, a fragrance product, a flavor product, and an inhalable product. The augmenting or enhancing may include adding to the product an aroma compound selected from 3-mercaptohexyl acetate (3MHA), 3-mercaptohexanol (3MH), 3-mercaptohexyl hexanoate (3MHH), 3-mercaptohexyl butyrate (3MHB), or a combination of any two or more thereof. In certain embodiments, the edible product produced by the process is provided. In certain embodiments, the edible product is a food or beverage product. In certain embodiments, the beverage is beer, any alcohol-containing beverage, or other non-alcohol containing beverage product. In certain embodiments, the method for enhancing citrus aroma in a flavor or fragrance composition includes adding to the flavor or fragrance composition, an aroma compound selected from 3-mercaptohexyl acetate (3MHA), 3-mercaptohexanol (3MH), 3-mercaptohexyl hexanoate (3MHH), 3-mercaptohexyl butyrate (3MHB), or combination of any two or more thereof.

Yet another aspect of the present technology relates to a method of producing a proven citrus aroma composition comprising mixing a terpene compound with an aroma compound selected from the group consisting of 3-mercaptohexyl acetate (3MHA), 3-mercaptohexanol (3MH), 3-mercaptohexyl hexanoate (3MHH), and 3-mercaptohexyl butyrate (3MHB). Suitable terpene compounds may include the primary and secondary terpene compounds described herein. In certain embodiments, the primary terpene compound is selected from the group consisting of myrcene, β-caryophyllene, limonene, α-pinene, β-pinene, valencene, ocimene, and terpinolene. In certain embodiments, the secondary terpene compound selected from the group consisting of humulene, linalool, α-bisabolol, nerol, α-phellandrene, α-terpineol, farnesene, fenchyl alcohol, geraniol, menthol, citronellol, citronellal, geranyl acetate, nerolidol, and citral.

Aspects of the present technology relate to methods of breeding a cannabis plant, wherein the plant produces altered or non-natural amounts of one or more aroma compounds. In one embodiment, provided is a method for breeding an engineered plant, wherein said cannabis plant comprises one or more citrus aroma compound, wherein the engineered cannabis plant produced greater amounts of the aroma compound when compared to the amount of citrus aroma compound in a non-engineered or natural plant. Suitable aroma compounds include, without limitation, 3-mercaptohexyl acetate (3MHA), 3-mercaptohexanol (3MH), 3-mercaptohexyl hexanoate (3MHH), 3-mercaptohexyl butyrate (3MHB), or a combination of any two or more thereof. In addition to the aroma compound plant may also include one or more of an organosulfur compound, a cannabinoid active agent, and a terpene compound. Suitable organosulfur compounds include, without limitation, prenyl mercaptan, 2-methylthiophene, 3-methylthiophene, diprenyl disulfide, 3-methyl-2-buten-1-yl thiolacetate, 3-methyl-1-[(3-methyl-2-buten-1-yl)sulfanyl]-2-butene, prenylmethylthiol (1-(methylsulfanyl)-3-methyl-2-butene), prenyl thioacetate, thiogeraniol, or a combination of any two or more thereof. Suitable terpene compounds include, without limitation, myrcene, β-caryophyllene, α or β-Pinene, α or β-phellandrene, limonene, terpinolene, linalool, pinene, terpineol, fenchyl alcohol, α-bisabolol, camphene, terpinolene, humulene, geraniol, camphor, cedrene, 1-menthol, cis-β-ocimene, trans-β-ocimene, terpinene, delta-3-carene, isoborneol, nerol, valencene, farnesene (t), fenchone, ocimene, bergotamene, thujene, ylangene, sabinene hydrate, and the like, or a combination of any two or more thereof.

Other aspects of the present technology relate to methods for producing a citrus aroma compound, wherein said method comprises cultivating a plant, wherein said plant produces an aroma compound selected from the group consisting of 3-mercaptohexyl acetate (3MHA), 3-mercaptohexanol (3MH), 3-mercaptohexyl hexanoate (3MHH), 3-mercaptohexyl butyrate (3MHB), or a combination of any two or more thereof. In various embodiments, the 3-mercaptohexyl acetate (3MHA) is produced at a concentration of from about 0.000001 wt. % to about 0.3 wt. %. In various embodiments, the 3-mercaptohexyl butyrate (3MHB) is produced at a concentration of from about 0.000001 wt. % to about 0.2 wt. %. In various embodiments, the 3-mercaptohexanol (3MH) is produced at a concentration of from about 0.000001 wt. % to about 0.2 wt. %. In various embodiments, the 3-mercaptohexyl hexanoate (3MHH) is produced at a concentration of from about 0.000001 wt. % to about 0.2 wt. %.

The aroma compounds and terpenes described herein may be commercially sourced or can be readily prepared in a laboratory. The methods described herein uniquely allow the identification of key volatile aroma compounds in cannabis, which strongly contribute to citrus scent. The inventors discovered that these compounds, when combined with many of the other major terpenes often found in cannabis, advantageously create extremely unique citrus flavors and aromas.

The present invention, thus generally described, will be understood more readily by reference to the following examples, which are provided by way of illustration and are not intended to be limiting of the present invention.

### EXAMPLES

Various embodiments will be further clarified by the following examples, which are in no way intended to limit this disclosure thereto.

### Example 1: Curation of Cannabis Samples

Samples of cannabis flowers were curated from different sources. All samples were stored in clear, colorless scintillation vials in a −20° C. freezer to ensure minimal loss of volatiles and decrease thermal decomposition. All samples were dried and cured prior to procurement.

### Example 2: Sample Preparation

300 mg of each curated flower sample from Example 1 was transferred to 20 mL headspace vials followed by mechanically grinding with a spatula. Alternatively, 100 mg of Cannabis extract were transferred to 20 mL headspace vials. The sample vials were then immediately capped, and vial caps were then crimped onto each vial.

### Example 3: Identification of Aroma Compounds

Three different varieties of cannabis that possessed uniquely citrus aromas. These cultivars, their aroma characteristics, and approximate concentrations of 3-mercaptohexyl acetate (3MHA), 3-mercaptohexyl butyrate (3MHB), 3-mercaptohexanol (3MH), or 3-mercaptohexyl hexanoate (3MHH) are shown in Table 1.

| | | [3MHA] | [3MHB] | [3MH] | [3MHH] |
|---|---|---|---|---|---|
| Variety | Aroma | (μg/mg) | (μg/mg) | (μg/mg) | (μg/mg) |
| Sour Tangie | Pungent, rich, fatty | 0.0041 | 0.0021 | 0.030 | 0.017 |
| | petroleum-citrus, gassy | | | | |
| Tropicana | Pungent, petroleum- | 0.0025 | N/A | N/A | N/A |
| Cookies | citrus, fatty | | | | |
| Orange | Pungent, fatty, moderate | 0.0012 | N/A | N/A | N/A |
| Banana | petroleum- citrus | | | | |

### Comprehensive Two-Dimensional Gas Chromatography.

The three cannabis cultivars were analyzed using 2-dimensional gas chromatography, mass spectrometry, and flame ionization detector to determine the chemical origin of the citrus odor in cannabis. GC×GC analysis was performed using the INSIGHT reverse fill flush flow modulator (Sepsolve Analytical) in conjunction with a 7890B GC (Agilent technologies) and BenchTOF Select Time of flight mass spectrometer (Markes International). Detection and quantification of sulfur-bearing compounds was performed using a flame ionization detector (FID). Sample introduction was performed using the Centri sample preparation platform (Markes International).

Samples were incubated and agitated at a temperature of 130° C. for 10 minutes, followed by three 5 mL headspace injections from the headspace vial to a cryogen free cold trap held at 25° C. After the six injections were complete, the cold trap was rapidly heated to 300° C. to desorb the sample in a narrow band onto the analytical columns. The GC×GC column configuration was an apolar to polar setup. The GC oven ramp rates used were as follows: The oven was initially set to 45° C. and held for 3 minutes. The oven was then ramped at a rate of 5° C. per minute to 90° C., followed a 2.0° C. ramp rate to 130° C., followed last by a 5° C. ramp rate to 240° C. The modulation period set for the flow modulator was 7.2 seconds. Data was collected, integrated, and analyzed using the ChromSpace software platform (Sepsolve Analytical).

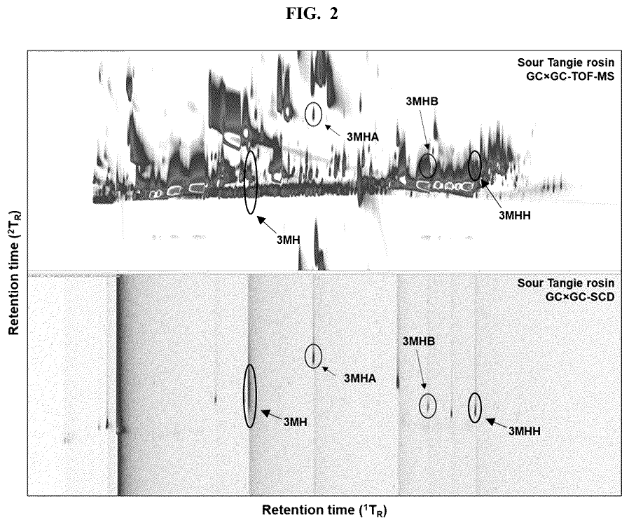

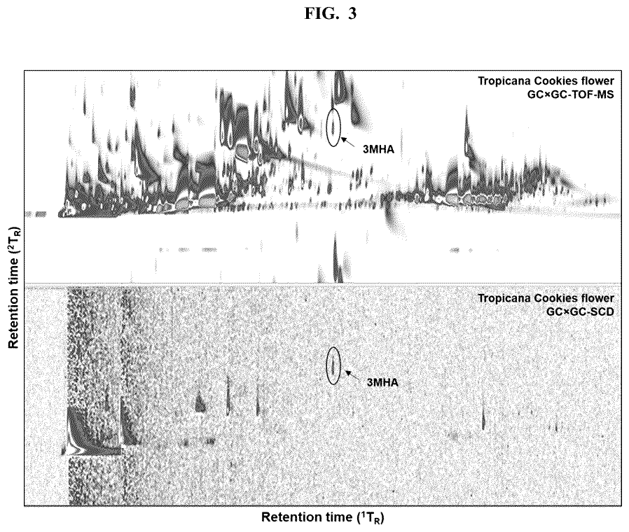

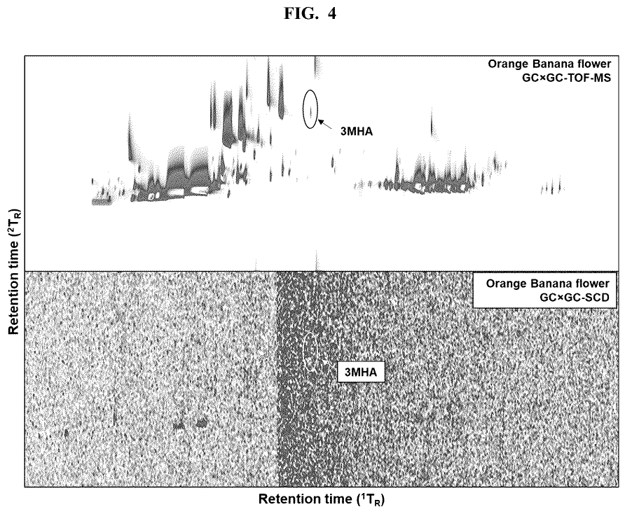

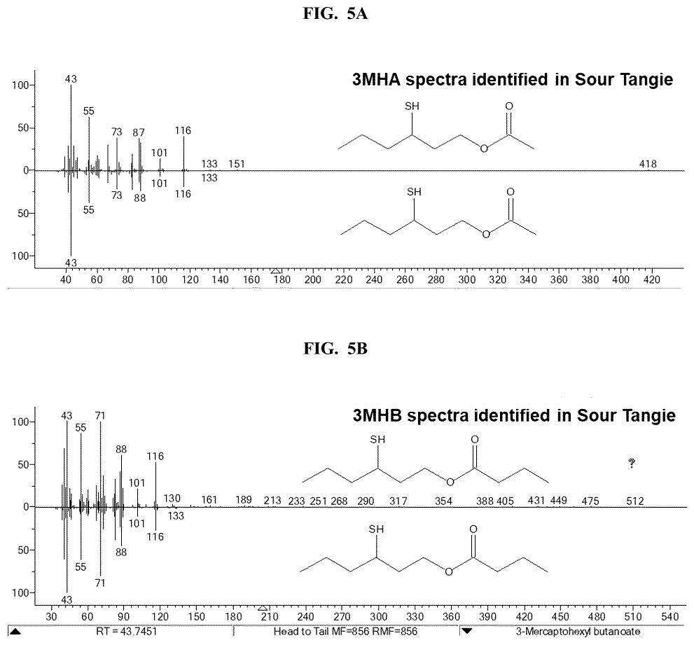

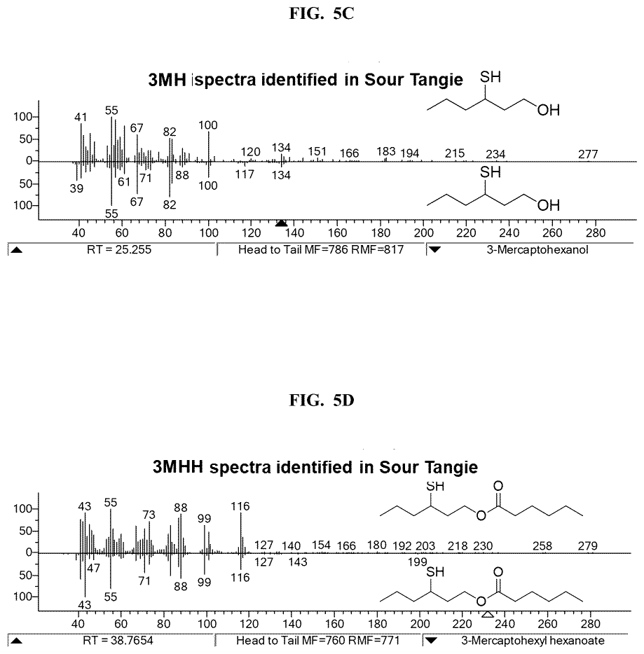

FIGS. 2, 3 and 4 show GC×GC-SCD and GC×GC-TOF-MS chromatograms for each tested cannabis cultivar variety, i.e., Sour Tangie, Tropicana Cookies, and Orange Banana. Sulfur chemiluminescence detects any compound that contains sulfur, and thus simplifies identification of these compounds significantly. For instance, in Sour Tangie (FIG. 2), 3MHA, 3MH, 3MHH, and 3MHB were quickly identified in the mass spectral data after detecting them in the SCD chromatogram. FIGS. 5A, 5B, 5C and 5D shows the mass spectra of 3MHA, 3MHB, 3MH, and 3MHH, respectively, in a Sour Tangie sample, compared with the mass spectral entries in the NIST structural database (2017). Of the three samples, Sour Tangie has the most pungent citrus aroma. While both Tropicana Cookies and Orange Banana each have 3MHA present, 3MHB, 3MH, and 3MHH were not detected. Thus, while 3MHA can combine with the other aroma compounds to yield a unique and pungent citrus scent, 3MHB, 3MH, and 3MHH add additional citrus notes to further intensify this aroma such as that observed in Sour Tangie.

Formulation of Cannabis Aroma Profiles with VSCs

Using the approximate concentrations obtained from the analysis of cultivars containing 3MHA, 3MH, 3MHH, and 3MHB, these four compounds were added to pre-prepared botanically derived terpene blends of six representative cannabis cultivars. These six cultivars were selected for at-least two reasons. First, they represent six very different aroma compositions that the cannabis plant produces. As cannabis can produce a wide range of aromas, it was elemental to test the 3MHA, 3MH, 3MHH and 3MHB compounds in combination with these divergent aromas. Secondly, each of these compositions contain a different dominant terpene. As the dominant terpene can dramatically influence the aromatic and flavor properties of these products, it was necessary to analyze how these different blends interact with the addition of 3MHA, 3MH, 3MHH, and 3MHB. Lastly, formulations that included prenyl thiol (PT) were further included, since this is a key component of the characteristic “skunky, gassy” aroma of cannabis.

### Example 4: Preparation and Testing of Blends

3MHA, 3MH, 3MHH, and 3MHB were purchased from Excellentia at 1% in Triacetin concentration, while PT at 1% in Triacetin was purchased from Penta Scientific. Pre-prepared terpene blends used were Abstrax Tech brand. 3MHA, 3MH, 3MHH, 3MHB, and PT were added by weight-% as shown in Table 3. A control trial for each was also conducted to compare the aroma properties of the unmodified blends to those with different additions of 3MHA, 3MH, 3MHH, 3MHB, and PT. The aroma properties of the prepared solutions were then determined using a trained tasting panel of five individuals.

In the trials of the six different aroma profiles, it was found that in each case, both compounds independently as well as combined yielded unique aromas that were significantly different from the original blends. The cultivars tested were purchased for testing purposes only. The aroma of the original blends is summarized in Table 3.

TABLE 3
Pre-prepared blends of cannabis cultivars.

| Blend Sample | Aroma | Terpenes |
|---|---|---|
| Sample A | Sweet, Citrus, Spicy, | Terpinolene, Beta-Caryophyllene, Limonene, |
| | Woody | Myrcene, Beta-Pinene |
| Sample B | Earthy, Pine, Wood | D-Limonene, Beta-Caryophyllene, Myrcene, |
| | | Linalool, Beta-Pinene |
| Sample C | Citrus, Sweet, Gassy | Linalool, Myrcene, Beta-Caryophyllene, D- |
| | | limonene, Humulene |
| Sample D | Tropical, Berry, Apple, | D-Limonene, Myrcene, Beta-Caryophyllene, |
| | Sweet, Fruit Punch | Linalool, Beta-Pinene |
| Sample E | Berry, Floral, Sweet | D-Limonene, Myrcene, Beta-Caryophyllene, |
| | | Linalool, Beta-Pinene |
| Sample F | Tropical, Fruity, Sweet | Ocimene, D-Limonene, Beta-Caryophyllene, |
| | | Alpha-Pinene, Linalool |

Further, when these compounds were used in conjunction with the major components found in these cannabis strains as well as prenyl thiol (i.e., prenyl mercaptan), which is a key odorant in cannabis that helps generate its unique skunky, gassy scent, the resulting aroma was further modified to yield unique gassy, petroleum-gassy aromas. This data shows that when common cannabis terpenes are used in conjunction with 3MHA, 3MH, 3MHH, 3MHB, and/or prenylthiol, they can produce unique and unexpected aromas.

Using cultivar blend samples A-F, the following blend compositions were prepared and tested. The compositions are summarized in Table 4.

TABLE 4
Effect of addition of 3MHA, 3MH, 3MHH, 3MHB, and PT on aroma
properties of pre-prepared blends of cannabis cultivars.

| | 3-MHA | 3MHB | PM | 3MH | 3MHH | |
|---|---|---|---|---|---|---|
| Blend | (%) | (%) | (%) | (%) | (%) | Aroma |
| Sample A0 | 0 | 0 | 0 | 0 | 0 | Pine, woody, spicy |
| (control) | | | | | | |
| Sample A1 | 0.02 | 0 | 0 | 0 | 0 | Petroleum-Citrus, spicy, |
| | | | | | | woody |
| Sample A2 | 0 | 0 | 0.02 | 0 | 0 | Skunky, spicy, woody |
| Sample A3 | 0 | 0.02 | 0 | 0 | 0 | sulfur, petroleum-citrus, |
| | | | | | | woody |
| Sample A4 | 0.03 | 0.02 | 0 | 0 | 0 | Petroleum-citrus, gassy, |
| | | | | | | woody |
| Sample A5 | 0 | 0 | 0 | 0.02 | 0 | citrus woody, spicy |
| Sample A6 | 0 | 0 | 0 | 0 | 0.02 | citrus woody, spicy, sulfuric |
| Sample A7 | 0.02 | 0.02 | 0 | 0.02 | 0.02 | woody, terpenic, intense |
| | | | | | | petroleum citrus |
| Sample A8 | 0.02 | 0.02 | 0.01 | 0.02 | 0.02 | intense petroleum citrus, |
| | | | | | | woody, gassy |
| Sample A9 | 0 | 0.02 | 0.03 | 0 | 0 | Skunk, intense petroleum- |
| | | | | | | citrus, woody |
| Sample A10 | 0.02 | 0 | 0.03 | 0 | 0 | Gassy, sulfur, intense |
| | | | | | | petroleum-citrus |
| Sample A11 | 0.02 | 0.01 | 0.03 | 0 | 0 | Sulfur, intense petroleum |
| | | | | | | citrus, woody |
| SampleB0 | 0 | 0 | 0 | 0 | 0 | Pine, earthy |
| (control) | | | | | | |
| Sample B1 | 0.02 | 0 | 0 | 0 | 0 | Petroleum-citrus, pine |
| Sample B2 | 0 | 0 | 0.02 | 0 | 0 | Gassy, pine |
| Sample B3 | 0 | 0.02 | 0 | 0 | 0 | Gassy, petroleum-citrus, |
| | | | | | | pine |
| Sample B4 | 0.03 | 0.02 | 0 | 0 | 0 | intense petroleum-citrus, |
| | | | | | | pine |
| Sample B5 | 0 | 0.02 | 0.03 | 0 | 0 | Gassy, strong petroleum- |
| | | | | | | citrus, pine |
| Sample B6 | 0.02 | 0 | 0.03 | 0 | 0 | Gassy, strong petroleum- |
| | | | | | | citrus, pine |
| Sample B7 | 0.02 | 0.01 | 0.03 | 0 | 0 | Gassy, intense petroleum- |
| | | | | | | citrus, pine |
| Sample B8 | 0 | 0 | 0 | 0.02 | 0 | musty, gassy, hint of |
| | | | | | | grapefruit, sulfuric, |
| | | | | | | petroleum citrus |
| Sample B9 | 0 | 0 | 0 | 0 | 0.02 | sulfuric, petroleum citrus, |
| | | | | | | camphor |
| Sample B10 | 0.02 | 0.02 | 0 | 0.02 | 0.02 | sulfuric, petroleum-citrus, |
| | | | | | | camphor |
| Sample B11 | 0.02 | 0.02 | 0.01 | 0.02 | 0.02 | gassy, musty, intense |
| | | | | | | petroleum citrus |
| Sample C0 | 0 | 0 | 0 | 0 | 0 | Mild citrus, slight floral |
| (control) | | | | | | |
| Sample C1 | 0.02 | 0 | 0 | 0 | 0 | Intense petroleum citrus, |
| | | | | | | petroleum |
| Sample C2 | 0 | 0 | 0.02 | 0 | 0 | Mild citrus, very gassy |
| Sample C3 | 0 | 0.02 | 0 | 0 | 0 | Intense petroleum citrus, |
| | | | | | | slight floral |
| Sample C4 | 0.03 | 0.02 | 0 | 0 | 0 | Very intense citrus, |
| | | | | | | petroleum |
| Sample C5 | 0 | 0.02 | 0.03 | 0 | 0 | intense citrus, petroleum, |
| | | | | | | gassy |
| Sample C6 | 0.02 | 0 | 0.03 | 0 | 0 | intense citrus, petroleum, |
| | | | | | | gassy |
| Sample C7 | 0.02 | 0.01 | 0.03 | 0 | 0 | Very intense citrus, |
| | | | | | | petroleum, gassy, grapefruit |
| Sample C8 | 0 | 0 | 0 | 0.02 | 0 | gassy, orange, fruity, |
| | | | | | | petroleum citrus |
| Sample C9 | 0 | 0 | 0 | 0 | 0.02 | gassy, orange, fruity, |
| | | | | | | sulfuric, petroleum citrus |
| Sample C10 | 0.02 | 0.02 | 0 | 0.02 | 0.02 | gassy, intense petroleum- |
| | | | | | | citrus, tangerine |
| Sample C11 | 0.02 | 0.02 | 0.01 | 0.02 | 0.02 | gassy, intense petroleum- |
| | | | | | | citrus, tangerine |
| Sample D0 | 0 | 0 | 0 | 0 | 0 | Sweet, slightly spicy |
| (control) | | | | | | |
| Sample D1 | 0.02 | 0 | 0 | 0 | 0 | Sweet, intense petroleum |
| | | | | | | citrus |
| Sample D2 | 0 | 0 | 0.02 | 0 | 0 | Sweet, gassy, skunky |
| Sample D3 | 0 | 0.02 | 0 | 0 | 0 | Sweet, petroleum citrus |
| Sample D4 | 0.03 | 0.02 | 0 | 0 | 0 | Sweet, very intense |
| | | | | | | petroleum citrus |
| Sample D5 | 0 | 0.02 | 0.03 | 0 | 0 | Sweet, intense petroleum |
| | | | | | | citrus, gassy |
| Sample D6 | 0.02 | 0 | 0.03 | 0 | 0 | Sweet, intense petroleum |
| | | | | | | citrus, gassy |
| Sample D7 | 0.02 | 0.01 | 0.03 | 0 | 0 | Sweet, very intense |
| | | | | | | petroleum citrus, gassy |
| Sample D8 | 0 | 0 | 0 | 0.02 | 0 | fruity, sweet, candy, |
| | | | | | | sulfuric, citrus, petroleum |
| Sample D9 | 0 | 0 | 0 | 0 | 0.02 | fruity, sweet, candy, |
| | | | | | | sulfuric, petroleum |
| Sample D10 | 0.02 | 0.02 | 0 | 0.02 | 0.02 | Intense petroleum-citrus, |
| | | | | | | sweet, candy, grape |
| Sample D11 | 0.02 | 0.02 | 0.01 | 0.02 | 0.02 | Intense petroleum-citrus, |
| | | | | | | sweet, candy, grape, gassy |
| Gelato 0 | 0 | 0 | 0 | 0 | 0 | Floral, sweet, mild citrus |
| (control) | | | | | | |
| Sample E1 | 0.02 | 0 | 0 | 0 | 0 | Intense petroleum citrus, |
| | | | | | | sweet, floral |
| Sample E2 | 0 | 0 | 0.02 | 0 | 0 | Gassy sweet, floral |
| Sample E3 | 0 | 0.02 | 0 | 0 | 0 | Intense petroleum citrus, |
| | | | | | | sweet, floral |
| Sample E4 | 0.03 | 0.02 | 0 | 0 | 0 | Very intense petroleum |
| | | | | | | citrus, sweet, floral |
| Sample E5 | 0 | 0.02 | 0.03 | 0 | 0 | Intense petroleum citrus, |
| | | | | | | sweet, floral, gassy |
| Sample E6 | 0.02 | 0 | 0.03 | 0 | 0 | Intense petroleum citrus, |
| | | | | | | sweet, floral |
| Sample E7 | 0.02 | 0.01 | 0.03 | 0 | 0 | Intense petroleum citrus, |
| | | | | | | sweet, floral |
| Sample E8 | 0 | 0 | 0 | 0.02 | 0 | fruity, sweet, berry, |
| | | | | | | terpenic, sulfuric, citrus, |
| | | | | | | petroleum |
| Sample E9 | 0 | 0 | 0 | 0 | 0.02 | fruity, sweet, berry, |
| | | | | | | terpenic, sulfuric, petroleum |
| Sample E10 | 0.02 | 0.02 | 0 | 0.02 | 0.02 | berry, sweet, petroleum- |
| | | | | | | citrus |
| Sample E11 | 0.02 | 0.02 | 0.01 | 0.02 | 0.02 | berry, sweet, petroleum- |
| | | | | | | citrus, gassy |
| Sample F0 | 0 | 0 | 0 | 0 | 0 | Very sweet, fruity, creamy |
| (control) | | | | | | |
| Sample F1 | 0.02 | 0 | 0 | 0 | 0 | Intense petroleum citrus, |
| | | | | | | sweet, fruity |
| Sample F2 | 0 | 0 | 0.02 | 0 | 0 | Gassy, skunky, sweet, fruity |
| Sample F3 | 0 | 0.02 | 0 | 0 | 0 | Intense petroleum citrus, |
| | | | | | | sweet, fruity |
| Sample F4 | 0.03 | 0.02 | 0 | 0 | 0 | Very intense petroleum |
| | | | | | | citrus, sweet, fruity |
| Sample F5 | 0 | 0.02 | 0.03 | 0 | 0 | Intense petroleum citrus, |
| | | | | | | sweet, fruity, gassy |
| Sample F6 | 0.02 | 0 | 0.03 | 0 | 0 | Intense petroleum citrus, |
| | | | | | | sweet, fruity, gassy |
| Sample F7 | 0.02 | 0.01 | 0.03 | 0 | 0 | Very intense petroleum |
| | | | | | | citrus, sweet, fruity, gassy |
| Sample F8 | 0 | 0 | 0 | 0.02 | 0 | Petroleum citrus, sweet, |
| | | | | | | fruity, gassy |
| Sample F9 | 0 | 0 | 0 | 0 | 0.02 | sulfuric, sweet, fruity, |
| | | | | | | gassy, petroleum citrus |
| Sample F10 | 0.02 | 0.02 | 0 | 0.02 | 0.02 | Intense petroleum citrus, |
| | | | | | | sweet, fruity, gassy, |
| Sample F11 | 0.02 | 0.02 | 0.01 | 0.02 | 0.02 | Intense petroleum citrus, |
| | | | | | | sweet, fruity, gassy |

These results confirm the origins of the unique citrus odor in cannabis and demonstrate how the aroma can be modulated through coupling of other compounds present in the cannabis plant.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

All disclosed ranges are to be understood to encompass and provide support for claims that recite any and all subranges or any and all individual values subsumed by each range. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth). Any listed range may be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like, include the number recited and refer to ranges which may be subsequently broken down into subranges as discussed above. Finally, as will be understood by one skilled in the art, a range includes each individual member. Thus, for example, a group having 1-3 layers refers to groups having 1, 2, or 3 layers. Similarly, a group having 1-5 layers refers to groups having 1, 2, 3, 4, or 5 layers, and so forth.

The drawings shall be interpreted as illustrating one or more embodiments that are drawn to scale and/or one or more embodiments that are not drawn to scale. This means the drawings may be interpreted, for example, as showing: (a) everything drawn to scale, (b) nothing drawn to scale, or (c) one or more features drawn to scale and one or more features not drawn to scale. Accordingly, the drawings can serve to provide support to recite the sizes, proportions, and/or other dimensions of any of the illustrated features either alone or relative to each other. Furthermore, all such sizes, proportions, and/or other dimensions are to be understood as being variable from 0-100% in either direction and thus provide support for claims that recite such values or any and all ranges or subranges that may be formed by such values.

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this document shall mean” or similar language (e.g., “this term means,” “this term is defined as,” “for the purposes of this disclosure this term shall mean,” etc.). References to specific examples, use of “i.e.,” use of the word “technology,” etc., are not meant to invoke exception (b) or otherwise restrict the scope of the recited claim terms. Other than situations where exception (b) applies, nothing contained in this document should be considered a disclaimer or disavowal of claim scope.

Unless otherwise defined, all terms (including technical and scientific terms) used herein have the same meaning as commonly understood by one of ordinary skill in the art to which this technology belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. While not explicitly defined below, such terms should be interpreted according to their common meaning.

In addition, where features or aspects of the disclosure are described in terms of Markush groups, those skilled in the art will recognize that the disclosure is also thereby described in terms of any individual member or subgroup of members of the Markush group.

Unless the context indicates otherwise, it is specifically intended that the various features of the technology described herein may be used in any combination. Moreover, the disclosure also contemplates that in certain embodiments, any feature or combination of features set forth herein may be excluded or omitted. To illustrate, if the specification states that a complex comprises components A, B and C, it is specifically intended that any of A, B or C, or a combination of any two or more thereof, may be omitted and disclaimed singularly or in any combination.

Unless explicitly indicated otherwise, all specified embodiments, features, and terms intend to include both the recited embodiment, feature, or term and biological equivalents thereof.

All patents, patent applications, provisional applications, and publications referred to or cited herein are incorporated by reference in their entirety, including all figures and tables, to the extent they are not inconsistent with the explicit teachings of this specification.

Other embodiments are set forth in the following claims.

What is claimed is:

1. A composition comprising:
an aroma compound comprising 3-mercaptohexyl acetate, 3-mercaptohexyl butyrate, 3-mercaptohexanol, 3-mercaptohexyl hexanoate, or a combination of any two or more thereof; and
a primary terpene compound;
wherein the composition is an edible composition, an aerosol composition, a flavor composition, a fragrance composition, or an inhalable composition.

2. The composition of claim 1 comprising about 0.000001 wt. % to about 0.3 wt. % of the aroma compound, based on a total weight of the composition.

3. The composition of claim 1, wherein the aroma compound comprises 3-mercaptohexyl acetate, 3-mercaptohexyl butyrate, or a combination of thereof.

4. The composition of claim 1, wherein the primary terpene compound is myrcene, β-caryophyllene, limonene, α-pinene, β-pinene, valencene, ocimene, terpinolene, or a combination of any two or more thereof.

5. The composition of claim 4, wherein the primary terpene compound is present in an amount of about 0.1 wt. % to about 99 wt. %, based on a total weight of the composition.

6. The composition of claim 1 further comprising a secondary terpene compound comprising humulene, linalool, bisabolol, nerol, phellandrene, terpineol, farnesene, fenchyl alcohol, geraniol, menthol, citronellol, citronellal, geranyl acetate, nerolidol, citral, or a combination of any two or more thereof.

7. The composition of claim 6, wherein the secondary terpene compound is present in an amount of about 0.01 wt. % to about 50 wt. %, based on a total weight of the composition.

8. The composition of claim 1 further comprising an organosulfur compound comprising prenyl mercaptan, 2-methylthiophene, 3-methylthiophene, diprenyl disulfide, 3-methyl-2-buten-1-yl thiolacetate, 3-methyl-1-[(3-methyl-2-buten-1-yl)sulfanyl]-2-butene, prenylmethylthiol (1-(methylsulfanyl)-3-methyl-2-butene), prenyl thioacetate, thiogeraniol, or a combination of any two or more thereof.

9. The composition of claim 8, wherein the organosulfur compound is present in an amount of about 0.000001 wt. % to about 0.3 wt. %, based on the total weight of the composition.

10. The composition of claim 1 further comprising a second flavoring or fragrance agent in an amount of about 0.000001% to about 90% by weight, based on a total weight of the composition.

11. The composition of claim 1, wherein the composition is an edible composition.

12. The composition of claim 1, wherein the composition is a food or beverage product.

13. The composition of claim 12, wherein the beverage is beer, an alcohol-containing beverage, or a non-alcohol containing beverage product.

14. The composition of claim 1, wherein the composition is an inhalation composition, a flavor and/or fragrance composition.

15. A process for augmenting or enhancing the citrus aroma or taste of a product, the process comprising adding to said product an aroma compound comprising 3-mercaptohexyl acetate, 3-mercaptohexyl butyrate, 3-mercaptohexanol, 3-mercaptohexyl hexanoate, or a combination of any two or more thereof.

16. The process of claim 15, wherein the aroma compound is added in an amount of about 0.000001 wt. % to about 0.6 wt. %, based on a total weight of the product.

17. The process of any one of claim 15, wherein the aroma compound comprises about 0.000001 wt. % to about 0.3 wt. % of 3-mercaptohexyl acetate, about 0.000001 wt. % to about 0.2 wt. % of 3-mercaptohexyl butyrate, about 0.0000001 wt. % to about 0.3% of 3-mercaptohexanol, about 0.0000001 wt. % to about 0.3% of 3-mercaptohexyl hexanoate, or a combination of any two or more thereof.

18. The process of claim 15 further comprising adding a primary terpene compound comprising myrcene, β-caryophyllene, limonene, α-pinene, β-pinene, valencene, ocimene, terpinolene, or a combination of any two or more thereof.

19. The process of claim 18, wherein the primary terpene compound is added in an amount of about 0.1 wt. % to about 99 wt. %, based on a total weight of the composition.

20. The process of claim 19, wherein the product is an edible product or an inhalable product.
